(19) United States
(12) Patent Application Publication
(10) Pub. No.: US 2021/0336523 A1
(43) Pub. Date: Oct. 28, 2021

(54) PERMANENT MAGNET MOTOR

(71) Applicants: Joseph F. Ouellette, Glendale, MO (US); Richard J. Ouellette, Fenton, MO (US)

(72) Inventors: Joseph F. Ouellette, Glendale, MO (US); Richard J. Ouellette, Fenton, MO (US)

(21) Appl. No.: 17/242,492

(22) Filed: Apr. 28, 2021

Related U.S. Application Data
(60) Provisional application No. 63/016,610, filed on Apr. 28, 2020.

(51) Int. Cl. H02K 53/00; H02K 1/02; H02K 7/116

(52) U.S. Cl. CPC H02K 53/00; H02K 7/116; H02K 1/02

(57) ABSTRACT

A permanent magnet motor is constructed of a plurality of permanent magnets arranged in a circular arrangement on a base of the motor, and with a first cylindrical magnet and a second cylindrical magnet mounted on respective first and second radial shafts that project from a gear box on a center shaft to positions over the circular arrangement of permanent magnets. The motor operates to move the first and second cylindrical magnets in rotation over the circular arrangement of the plurality of permanent magnets in response to a one time initial motion and does not require communication with any outside source of energy and does not require an input of energy to the permanent magnet motor for continued operation of the permanent magnet motor.

This patent application claims the benefit of the priority of the filing date of Apr. 28, 2020, of provisional patent application No. 63/016,610, incorporated herein by reference.

### FIELD

This disclosure pertains to the construction and operation of a permanent magnet motor. More specifically, this disclosure pertains to the construction and operation of a permanent magnet motor that operates in response to a one time initial motion and does not require communication with any outside source of energy and does not require an input of energy to the permanent magnet motor for continued operation of the permanent magnet motor.

### BACKGROUND

A typical electric motor employs permanent magnets. The permanent magnets are positioned in the electric motor on opposite sides of a rotor. The rotor is an electromagnet that communicates with an external power source. Power passed through the electromagnet of the rotor creates a rotor field that is attracted to the permanent magnets, causing the rotor to rotate. The electric power provided to the windings of the rotor is reversed, reversing the polarity of the rotor field and producing repulsion between the rotor and the permanent magnets. The repulsion force between the rotor field and the permanent magnets produces further rotation of the rotor. By sequentially reversing the polarity of the rotor, the rotor continues to rotate in the electric motor.

The typical electric motor described above employing permanent magnets also requires communication with an outside source of energy and the input of electric energy to the windings of the rotor to cause rotation of the rotor.

### SUMMARY

The permanent magnet motor of this disclosure operates in response to a one time initial motion or rotation of a center shaft of the motor and does not require communication with any outside source of energy and does not require an input of energy to the permanent magnet motor for continued operation of the permanent magnet motor.

The permanent magnet motor or motor is comprised of a plurality of permanent magnets that are positioned in a cylindrical arrangement on a base of the motor. The base is constructed of a non-magnetic material. The circular arrangement of permanent magnets on the base has a vertical axis of rotation. The plurality of permanent magnets in the circular arrangement have upwardly facing surfaces with alternating north pole polarity surfaces and south pole polarity surfaces.

A center shaft extends upwardly through the base. The center shaft is coaxial with the vertical axis of rotation The circular arrangement of the plurality of permanent magnets extends around the center shaft.

A gear box is mounted to the top of the center shaft. The gear box contains a timing gear arrangement.

A first radial shaft extends outwardly from one side of the gear box. The first radial shaft is mounted in the gear box for rotation of the first radial shaft relative to the gear box and has a horizontal axis of rotation.

A second radial shaft extends radially outward from the gear box. The second radial shaft extends radially outward from the gear box on the opposite side of the gear box from the first radial shaft. The second radial shaft is mounted to the gear box for rotation of the second radial shaft relative to the gear box. The second radial shaft has a horizontal axis of rotation that is coaxial with the horizontal axis of rotation of the first radial shaft.

A first cylindrical permanent magnet is secured to the first radial shaft for rotation of the first cylindrical permanent magnet with rotation of the first radial shaft. The first cylindrical permanent magnet is positioned on the first radial shaft over the circular arrangement of the plurality of permanent magnets. The first cylindrical permanent magnet has opposite halves positioned on opposite sides of the first radial shaft. The opposite halves of the first cylindrical magnet have opposite north and south polarities on opposite sides of the horizontal axis of rotation of the first radial shaft.

A second cylindrical permanent magnet is secured to the second radial shaft for rotation of the second cylindrical permanent magnet with rotation of the second radial shaft. The second cylindrical permanent magnet is positioned on the second radial shaft over the circular arrangement of the plurality of permanent magnets. The second cylindrical permanent magnet has opposite halves positioned on opposite sides of the second radial shaft. The opposite halves of the second cylindrical magnet have opposite north and south polarities on opposite sides of the horizontal axis of rotation of the second radial shaft.

A first wheel is mounted on an outer end of the first radial shaft. The first wheel is positioned to rotate on the base in a circular pattern around the circular arrangement of the plurality of permanent magnets.

A second wheel is mounted on an outer end of the second radial shaft. The second wheel is positioned to rotate on the base in a circular pattern around the circular arrangement of the plurality of permanent magnets.

### BRIEF DESCRIPTION OF THE DRAWINGS

FIG. 1 is a representation of a top, plan view of the permanent magnet motor of this disclosure.

FIG. 2 is a representation of a front, elevation view of the motor.

FIG. 3 is a representation of a left side elevation view of the motor, the right side elevation view being a mirror image thereof.

FIG. 4 is a schematic representation of a partial view of a side elevation view of the motor 2 along the line 4-4 of FIG. 1.

FIG. 5 is a schematic representation of a partial view of a side elevation view of the motor 2 where the permanent magnets are all level.

FIG. 6 is a schematic representation similar to that of FIG. 4, but with the slanted orientation of the permanent magnets reversed.

### DETAILED DESCRIPTION

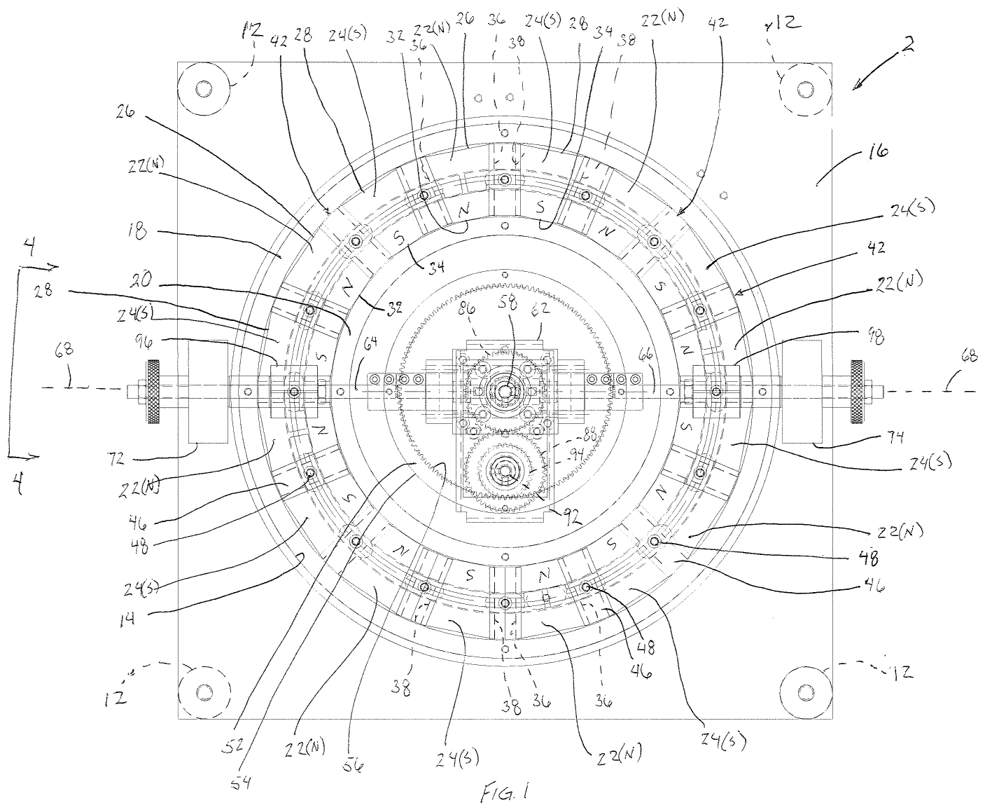

A representation of a top, plan view of the permanent magnet motor 2 of this disclosure is provided in FIG. 1. The component parts of the motor 2 to be described are constructed of magnetic materials and non-magnetic materials. The magnetic materials are magnetic metals, and more specifically rare earth magnets. The non-magnetic materials could be non-magnetic metals, for example non-ferrous metals or non-magnetic materials such as composite materials, or other equivalent types of non-magnetic materials.

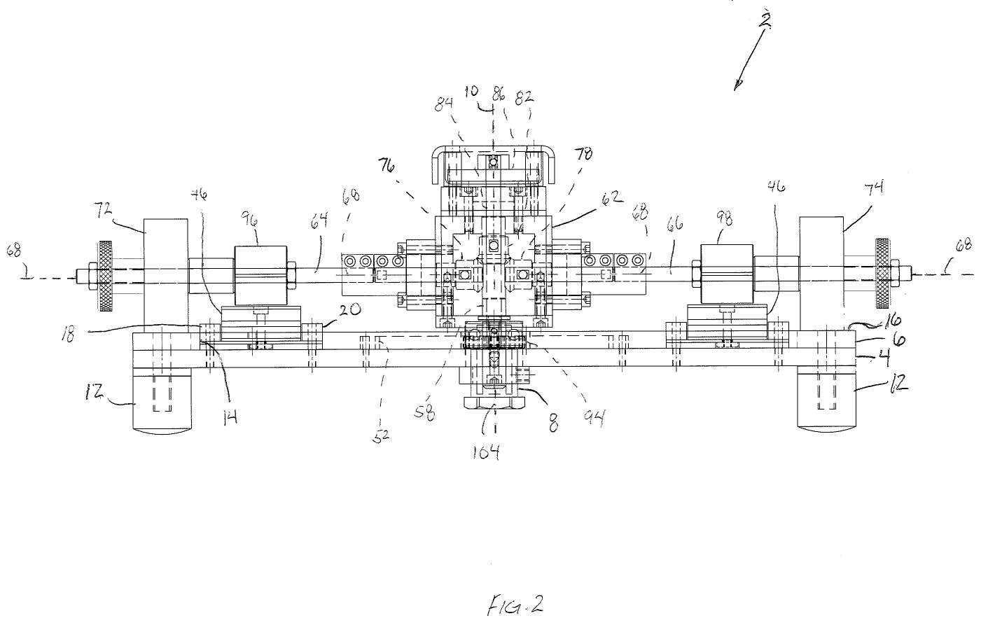

The permanent magnet motor 2 is supported on a non-metallic base comprised of a bottom plate 4 and a top plate 6. Both the bottom plate 4 and the top plate 6 are shown having a square configuration. However, the bottom plate 4 and the top plate 6 could also have other configurations, for example round configurations. Both the bottom plate 4 and the top plate 6 are constructed of non-magnetic materials, for example aluminum. As represented in FIGS. 2 and 3, the bottom plate 4 has a hole at its center that supports a bushing 8. The hole and the bushing 8 are coaxial and have a vertical axis of rotation 10. Four supports 12 are connected to the underside of the bottom plate 4 at the four corners of the bottom plate 4. The four supports support the permanent magnet motor 2. The four supports 12 are constructed of non-magnetic material.

A circular recess having a cylindrical inner wall 14 is formed in the upper surface 16 of the top plate 6. The cylindrical inner wall 14 of the recess is cocentric with the bushing 8 and the axis 10.

A circular outer rim 18 is secured to the top of the bottom plate 4. The outer rim 18 is positioned inside the cylindrical inner wall 14 of the recess in the top plate 6. The circular outer rim 18 is concentric with the cylindrical inner wall 14. The circular outer rim 18 is constructed of a non-magnetic material.

A circular inner rim 20 is secured to the top of the bottom plate 4. The circular inner rim 20 is concentric with the circular outer rim 18. The circular inner rim 20 is constructed of a non-magnetic material.

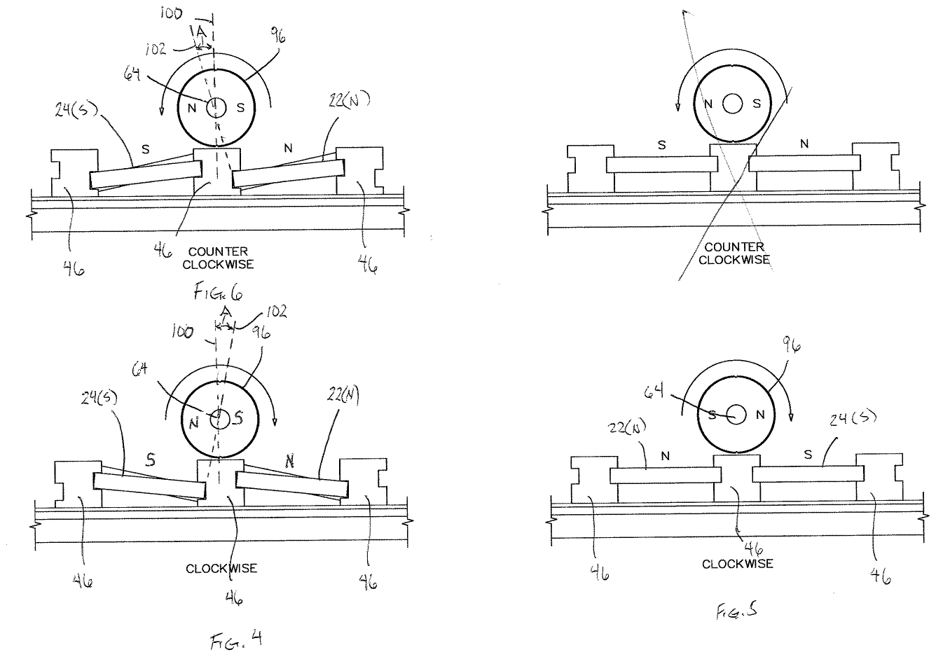

A plurality of permanent magnets 22(N), 24(S) are positioned in a circular arrangement between the outer rim 18 and the inner rim 20. Each of the permanent magnets 22(N), 24(S) preferably are rare earth magnets, and each magnet has a polygonal configuration. The polygonal configuration of each of the magnets 22(N), 24(S) is the same. Each of the magnets 22(N), 24(S) has a long, outer edge 26(N), 28(S), respectively, and short inner edge 32(N), 34(S) opposite the outer edge 26(N), 28(S), respectively. The outer edges 26(N), 28(S) of the magnets 22(N), 24(S) abut against the interior surface of the outer rim 18. The inner edges (32(N), 34(S) of the magnets 22(N), 24(S) abut against the exterior surface of the inner rim 20. Each of the permanent magnets 22(N), 24(S) also have opposite side edges 36(N), 38(S). As represented in FIG. 1, each of the permanent magnets 22(N), 24(S) is configured and dimensioned with the same configuration, and so when the permanent magnets 22(N), 24(S) are arranged in the circular arrangement between the rims 18, 20 as represented in FIG. 1, there is an equal spacing 42 between the opposed side edges 36(N), 38(S) of adjacent magnets. As represented in FIG. 1, the permanent magnets 22(N), 24(S) are arranged on the bottom plate 4 top surface in a circular pattern between the rims 18, 20. In the circular pattern of the magnets 22(N), 24(S) the magnets alternate with their north pole 22(N) surfaces facing upwardly from the bottom plate 4 and their south pole surfaces facing downwardly toward the bottom plate 4, and with their south pole 24(S) surfaces facing upwardly from the bottom plate 4 and their opposite north pole surfaces facing downwardly toward the base top surface 14. The upwardly facing north pole 22(N) surfaces and the upwardly facing south pole 24(S) surfaces are each angled relative to the bottom plate 4 and top plate 6 to drive the motor rotation in a counterclockwise direction, as will be explained. In an alternative arrangement, the upwardly facing surfaces could all be level and in a single plane as represented in FIG. 5. The angled surfaces are preferred for better operation.

A plurality of retaining blocks 46 are positioned in the spacings 42 between the opposing side edges 36(N), 38(S) of the permanent magnets 22(N), 24(S). The retaining blocks 46 are constructed of non-magnetic materials. The retaining blocks 46 are secured to the bottom plate 4 by threaded fasteners 48. The threaded fasteners 48 are also constructed of non-magnetic materials. The retaining blocks 46 secure the permanent magnets 22(N), 24(S) to the bottom plate 4 in their spaced arrangement and alternating polarity arrangement represented in FIG. 1.

A ring gear 52 is secured to the top surface of the bottom plate 4. The ring gear 52 is constructed of non-magnetic materials. The ring gear 52 is concentric with the outer rim 18, the inner rim 20 and the plurality of permanent magnets 22(N), 24(S). The inner edge of the ring gear 52 has a circular pattern of gear teeth 56.

A center shaft 58 that is coaxial with the axis of rotation 10 extends vertically upwardly from the center of the bottom plate 4. The center shaft 58 is constructed of non-magnetic material. The center shaft 58 is at the center of the ring gear 52.

A gear box 62 is mounted on the center shaft 58. The gear box 62 is constructed of non-magnetic materials. The gear box 62 is mounted on the center shaft 58 for rotation of the gear box about the center shaft.

A first radial shaft 64 extends into one side or a first side of the gear box 62 and extends radially out from the gear box, and a second radial shaft 66 extends into the opposite side or a second side of the gear box 62 and extends radially out from the gear box. The first radial shaft 64 and the second radial shaft 66 are constructed of nonmagnetic materials. Both the first radial shaft 64 and the second radial shaft 66 are mounted to the gear box 62 for rotation of the radial shafts relative to the gear box. Both the first radial shaft 64 and the second radial shaft 66 are separate shafts and have the same horizontal axis of rotation 68.

There is a first wheel 72 mounted on an outer end of the first radial shaft 64. The first wheel 72 is an idler wheel that rotates on the first radial shaft 64 in response to the first radial shaft 64 moving in a counterclockwise rotation around the bushing 8 as viewed in FIG. 1. The first wheel 72 is positioned to rotate on the top surface 16 of the top plate 6 in a circular pattern around the outside of the rim 18. The first wheel 72 is constructed of a non-magnetic resilient material, for example urethane or other similar material and is mounted on a radial bearing that is mounted on the first radial shaft 64.

A second wheel 74 is mounted on the outer end of the second radial shaft 66. The second wheel 74 is an idler wheel that rotates on the second radial shaft 66 moving in a counterclockwise rotation around the bushing 8 as viewed in FIG. 1, The second wheel 74 is positioned to rotate on the top surface 16 of the top plate 6 in a circular pattern around the outside of the rim 18. The second wheel 74 is constructed of a non-magnetic resilient material, for example, urethane or other similar material and is mounted on a radial bearing that is mounted on the second radial shaft 66.

A first bevel gear 76 is mounted on the inner end of the first radial shaft 64 inside the gear box 62. The first bevel gear 76 is constructed of a non-magnetic material.

A second bevel gear 78 is mounted on the inner end of the second radial shaft 66 inside the gear box 62. The second bevel gear 78 is constructed of a non-magnetic material.

A third bevel gear 82 is mounted on a bottom end of a drive shaft 84 inside the gear box 62. The third bevel gear 82 meshes with the first bevel gear 76 and the second bevel gear 78. The third bevel gear 82 and drive shaft 84 are constructed of a non-magnetic material. The drive shaft 84 extends upwardly from the third bevel gear 82 and out of the top of the gear box 62. A top end of the drive shaft 84 is connected to a drive gear 86 that is outside the top of the gear box 62. The drive gear 86 is constructed of a non-magnetic material.

The first bevel gear 76, the second bevel gear 78 and the third bevel gear 82 are part of a gear train inside the gear box 62. The gear train is part of a timing gear train that is connected to the drive gear 86 outside the gear box 62. The drive gear 86 meshes with an upper pinion gear 88 outside the gear box 62. The upper pinion gear 88 is connected by a pinion shaft 92 to a lower pinion gear 94. The lower pinion gear 94 meshes with the ring gear 52. Together the first bevel gear 76, second bevel gear 78 and third bevel gear 82 in the gear box 62, the ring gear 52, the lower pinion gear 94, the upper pinion gear 88 and the drive gear 86 provide a timing gear arrangement that controls the rotation of the first radial shaft 64 and the second radial shaft 66 about the horizontal axis of rotation 68 of the two separate radial shafts as the first radial shaft 64 and the second radial shaft 66 move in a counterclockwise rotation around the bushing 8 and the first wheel 72 and second wheel 74 function as idler wheels that support the rotating radial shafts 64, 66 as the radial shafts 64, 66 move in a counterclockwise rotation over the permanent magnets 22, 24.

There is a first cylindrical magnet 96 secured to the first radial shaft 64 over the circular arrangement of the permanent magnets 22, 24. The first cylindrical magnet 96 is a rare earth magnet. There is a second cylindrical magnet 98 secured to the second radial shaft 66 over the circular arrangement of the permanent magnets 22, 24. The second cylindrical magnet 98 is a rare earth magnet. Both the first cylindrical magnet 96 and second cylindrical magnet 98 have opposite halves with opposite north (N) and south (S) polarities on opposite sides of the horizontal axis of rotation 68 of the first radial shaft 64 and the second radial shaft 66. Rotation of the first cylindrical magnet 96 and the second cylindrical magnet 98 about the horizontal axis of rotation 68 drives the rotation of the first radial shaft 64 and the second radial shaft 66 in a counterclockwise rotation over the circular pattern of permanent magnets 22(N), 24(S) and thereby drives rotation of the gear box 62 around the center shaft 58.

The speed of rotation of the gear box 62 around the center shaft 58 is controlled by the speed of rotation of the first cylindrical magnet 96 and the first radial shaft 64 secured to the first cylindrical magnet 96 about the horizontal axis of rotation 68, the speed of rotation of the second cylindrical magnet 98 and the second radial shaft 66 secured to the second cylindrical magnet 98 about the horizontal axis of rotation 68, the timing gear arrangement made up by the ring gear 52, the lower pinion gear 94, the upper pinion gear 88, the drive gear 86, the first bevel gear 76, the second bevel gear 78 and the third bevel gear 82. In response to the first cylindrical magnet 96 and the second cylindrical magnet 98 rotating about the horizontal axis of rotation 68, the first radial shaft 64 and the second radial shaft 66 also rotate about the horizontal axis of rotation 68 and move the first wheel 72 and second wheel 74 respectively as idler wheels over the top surface 16 of the top plate 6. This in turn rotates the first bevel gear 76, the second bevel gear 78 and the third bevel gear 82 inside the gear box, and rotates the gear box 62 about the center shaft 58. The rotation of the gear box 62 about the center shaft 58 is controlled by the timing gear arrangement provided by the first bevel gear 76, the second bevel gear 78 and the third bevel gear 82 inside the gear box 62, and by the ring gear 52, the lower pinion gear 94, the upper pinion gear 88 and the drive gear 86.

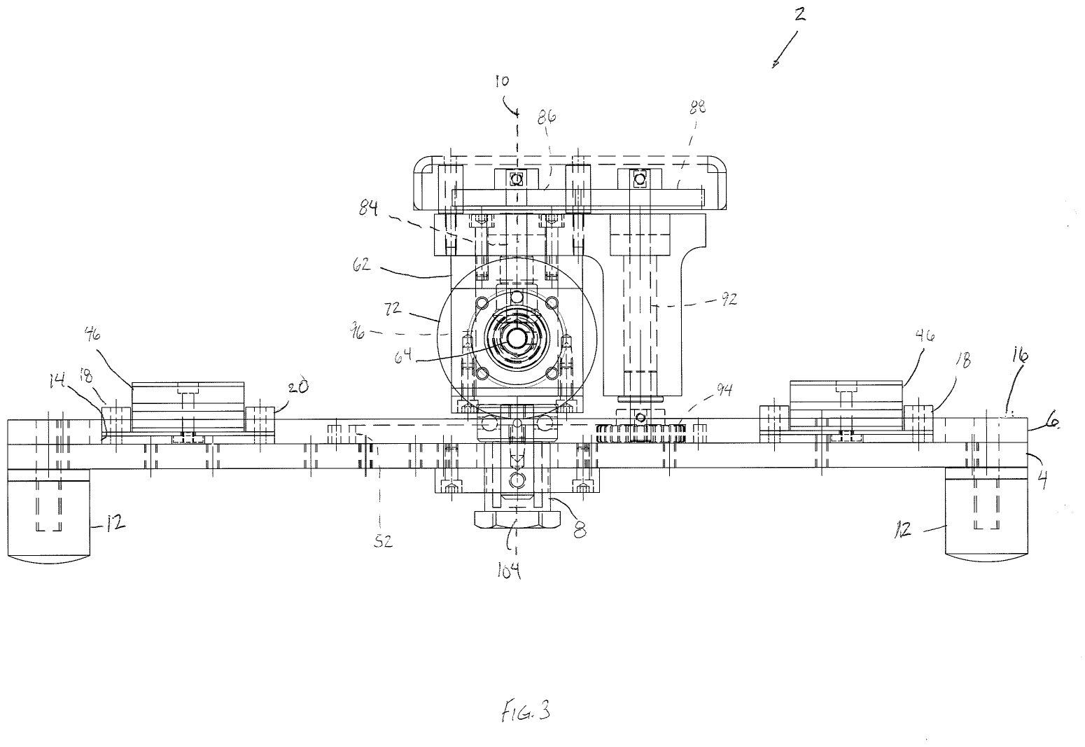

The operation of the permanent magnet motor 2 is initiated as represented in FIGS. 1 and 4. FIG. 4 is a schematic representation of an elevation view of the outer end of the first radial shaft 64 and the first cylindrical magnet 96 secured to the first radial shaft 64. Referring to FIG. 1, the first radial shaft 64 and the second radial shaft 66 are positioned at opposite sides of the circular pattern of permanent magnets 22(N), 24(S) with the first radial shaft 64 and the second radial shaft 66 positioned over retaining blocks 46 as represented in FIG. 1. In the positions of the first radial shaft 64 and the second radial shaft 66 represented in FIG. 1, the shafts 64, 66 are positioned over the retaining blocks 46 so that their respective cylindrical magnets 96, 98 are positioned over retaining blocks 46.

The following is a description of the operation of the first cylindrical magnet 96 and the first radial shaft 64 in driving the motor to rotate the first radial shaft 64 and the second radial shaft 66 in a counterclockwise rotation as represented in FIG. 1. It should be understood that the operation of the first radial shaft 64 and the first cylindrical magnet 96 secured to the first radial shaft 64 is the same operation as the second radial shaft 66 and the second cylindrical magnet 98 secured to the second radial shaft 66, although only the outer end of the first radial shaft 64 and the first cylindrical magnet 96 is represented in FIG. 4.

Referring to FIG. 4, a vertically oriented center plane 100 is represented in dashed lines. The center plane 100 is perpendicular to the horizontally oriented top surface of the retaining block 46. The center plane extends through the center of the first cylindrical magnet 96 in the position of the first cylindrical magnet 96 over the retaining block 46 represented in FIG. 4. The first cylindrical magnet 96 and the second cylindrical magnet 98 are supported in positions spaced just above the retaining blocks 46 by their respective radial shafts 64, 66 and the gear box 62. The gear box 62 in turn is supported on the bushing 8 for rotation of the gear box 62 on the bushing 8. The bushing 8 has an adjustable feature that can adjust the height of the gear box 62 above the bushing 8. The bushing 8 has a hex nut shaped adjusting knob 104 that can be turned to adjustably raise a thrust bearing 106 that supports the gear box 62. By adjusting the height of the thrust bearing 102 the height of the gear box 62 can be adjusted to adjust the positions of the first cylindrical magnet 96 and the second cylindrical magnet 98 to just above the retaining brackets 46 below the magnets so that there is a slight spacing between the magnets and the retaining blocks 46 below the magnets.

Prior to operation of the permanent magnet motor 2, the first radial shaft 64 and the second radial shaft 66 are held or otherwise retained in the positions represented in FIG. 1. In the positions represented in FIG. 1, the positive or north polarity (N) half of the first cylindrical magnet 96 and the negative or south polarity (S) half of the first cylindrical magnet 96 are as represented in FIG. 4.

Also represented in FIG. 4 is a dividing plane 102 of the first cylindrical magnet 96 represented by dashed lines. The dividing plane 102 extends through the center of the first cylindrical magnet 96 between the north polarity (N) and the south polarity (S) halves of the magnet 96. As represented in FIG. 4, the dividing plane 102 is oriented at a small angle A from the center plane 100. This represents the first cylindrical magnet 96 being rotated in a clockwise direction as represented in FIG. 4 until the dividing plane 102 is oriented at the small angle A from the center plane 100. The angle A could be in a range from 0°-10°. The angle A positions the south polarity (S) half of the first cylindrical magnet 96 in close proximity to the adjacent north polarity (N) permanent magnet 22(N) and positions the north polarity (N) half of the first cylindrical magnet 96 further away from the adjacent south polarity (S) permanent magnet 24(S). As represented in FIG. 4, the negative or south polarity (S) half of the first cylindrical magnet 96 is facing toward the adjacent positive or north polarity (N) surface of the adjacent permanent magnet 22(N) shown to the right in FIG. 4. Represented in FIG. 4, the slanted configuration of the adjacent north polarity magnet 22(N) positions a leading edge or a left hand edge of the magnet 22(N) as represented in FIG. 4 in close proximity to the south polarity (S) half of the first cylindrical magnets 96 where a trailing edge of the slanted adjacent permanent magnet 24(S) is positioned further away from the positive polarity (N) half of the first cylindrical magnet 96. Because the leading edge of the north polarity (N) magnet 22(N) is closer to the south polarity (S) half of the cylindrical first magnet 96 than the trailing edge of the south polarity (S) permanent magnet 24(S), the first cylindrical magnet 96 will be pulled to the right as represented in FIG. 4 toward the raised or closer leading edge of the north polarity magnet 22(N). This causes the first cylindrical magnet 96 to move to the right as represented in FIG. 4 and causes both the first cylindrical magnet 96 and second cylindrical magnet 98 to rotate the first radial shaft 64 and second radial shaft 66 in a counterclockwise direction as viewed in FIG. 1. The counterclockwise movement of the first radial shaft 64 and the second radial shaft 66 causes the wheels 72, 74 to rotate around the rim outer 18 on the base top surface 16. The counterclockwise movement of the first radial shaft 64 and second radial shaft 66 also causes the gear box 62 to rotate in a counterclockwise direction around the center shaft 58. This movement of the gear box 62 causes the timing gear train formed by the ring gear 52, the lower pinion gear 94, the upper pinion gear 88, the drive gear 86, the first bevel gear 76 on the first radial shaft 64, the second bevel gear 78 on the second radial shaft 64 and the third bevel gear 82 to rotate the first radial shaft 64 and second radial shaft 66 in a clockwise rotation as viewed from the outer ends of the first radial shaft 64 and second radial shaft 66. This rotation of the first radial shaft 64 and second radial shaft 66 causes rotation of the first cylindrical magnet 96 secured to the first radial shaft 64 and the second cylindrical magnet 98 secured to the second radial shaft 66. The rotation of the first radial shaft 64 and the second radial shaft 66 in a clockwise direction as viewed from the outer ends of the shafts also rotates the first cylindrical magnet 96 and the second cylindrical magnet 98 in a clockwise direction. The rotation of the first radial shaft 64 and the first cylindrical magnet 96 secured to the shaft, and the rotation of the second radial shaft 66 and the second cylindrical magnet 98 secured to the shaft is timed by the timing gear train so that the negative or south polarity (S) halves of each of the cylindrical magnets 96, 98 pass over the adjacent positive or north polarity (N) surfaces of the permanent magnets 22(N) until the first cylindrical magnet 96 and the second cylindrical magnet 98 are positioned above the retaining block 46 on the opposite side of the permanent magnet 22(N) from where they started, which was represented in FIG. 4. At the positions of the first cylindrical magnet 96 and second cylindrical magnet 98 above the retaining block 46, the vertical dividing plane 102 separating the positive or north polarity 22(N) half of the cylindrical magnets from the negative or south polarity (S) half of the cylindrical magnets is again positioned above the retaining block 46. This positions the positive or north polarity (N) halves of the first cylindrical magnet 96 and second cylindrical magnet 98 adjacent raised, leading edges of the top surface of the adjacent permanent magnets 24(S). The attraction of the positive or north polarity (N) halves of the first cylindrical magnet 96 and second cylindrical magnet 98 toward the negative polarity (S) top surfaces of the adjacent magnets 24(S) continues to pull the first radial shaft 64 and the second radial shaft in the counterclockwise direction around the center shaft 58 as represented in FIG. 1.

Thus, the rotation of the first radial shaft 64 and the first cylindrical magnet 96 secured to the shaft and the rotation of the second radial shaft 66 and the second cylindrical magnet 98 secured to the shaft is controlled by the timing circuit comprised of the first bevel gear 76 on the inner end of the first radial shaft 64 and the second bevel gear 78 on the inner end of the second radial shaft 66, the third bevel gear 82, the ring gear 52, the lower pinion gear 94 meshing with the ring gear 52, and the upper pinion gear 88 meshing with the drive gear 86. The timing gear train rotating the first radial shaft 64 and second radial shaft 66 in a clockwise direction about the horizontal axis of rotation 68 as the first radial shaft 64 and second radial shaft 66 move in a counterclockwise direction around the center shaft 58 controls the sequential positioning of the positive or north polarity (N) halves of the first cylindrical magnet 96 and the second cylindrical magnet 98 adjacent the raised, leading edge of the negative or south polarity (S) surfaces of the permanent magnets 24(S), and controls the positioning of the negative or south polarity (S) halves of the first cylindrical magnet 96 and the second cylindrical magnet 98 adjacent the raised, leading edges of the positive or north polarity (N) surfaces of the permanent magnets 22(N) as the first radial shaft 64 and second radial shaft 66 are continued to be rotated around the center shaft 58. This controlled, sequential positioning of the positive or north polarity (N) halves of the first cylindrical magnet 96 and second cylindrical magnet 98 adjacent the raised, leading edges of the negative or south polarity (S) surfaces of the permanent magnets 24(S), and the negative or south polarity (S) halves of the first cylindrical magnet 96 and the second cylindrical magnet 98 adjacent the raised, leading edges of the positive or north polarity (N) surfaces of the permanent magnets 22(N) results in the first radial shaft 64 and the second radial shaft 66 to be continued to be rotated in a counterclockwise direction around the center shaft 58 and causes the rotation of the gear box 62 in a counterclockwise direction around the center shaft 58 to be continued without the input of any energy into the permanent magnet motor 10.

FIG. 6 is a schematic representation similar to that of FIG. 4, but with the slant of the magnets 22(N), 24(S) reversed. This reverses the rotation of the motor 2 to a clockwise rotation as viewed in FIG. 1. As represented in FIG. 6, the positive or north polarity (N) half of the first cylindrical magnet 96 is facing toward the adjacent negative or south polarity (S) surface of the adjacent permanent magnet 24(S) shown to the left in FIG. 6. Represented in FIG. 6, the slanted configuration of the adjacent south polarity magnet 24(S) positions a leading edge or a right hand edge of the magnet 24(S) as represented in FIG. 6 in close proximity to the north polarity (N) half of the first cylindrical magnet 96 where a trailing edge of the slanted adjacent permanent magnet 22(N) is positioned further away from the negative polarity (S) half of the first cylindrical magnet 96. Because the leading edge of the south polarity (S) magnet 24(S) is closer to the north polarity (N) half of the first cylindrical magnet 96 than the trailing edge of the north polarity (N) permanent magnet 22(N), the first cylindrical magnet 96 will be pulled to the left as represented in FIG. 6 toward the raised or closer leading edge of the south polarity magnet 24(S). This causes the first cylindrical magnet 96 to move to the left as represented in FIG. 6 and causes both the first cylindrical magnet 96 and second cylindrical magnet 98 to rotate the first radial shaft 64 and second radial shaft 66 in a clockwise direction as viewed in FIG. 1. The clockwise rotation of the first cylindrical magnet 96 and second cylindrical magnet 98 and the first radial shaft 64 and second radial shaft 66 is controlled in the same manner as the counterclockwise direction rotation of the first cylindrical magnet 96 and second cylindrical magnet 98 and the first radial shaft 64 and second radial shaft 66 described earlier.

The permanent magnets 22(N), 24(S) of the motor 2 and the first cylindrical magnet 96 and second cylindrical magnet 98 are very powerful magnets. Component parts of the motor 2 in close proximity to the permanent magnets 22(N), 24(S) and the first cylindrical magnet 96 and second cylindrical magnet 98 are constructed of non-ferrous materials. Component parts of the motor 2 that are not in close proximity to the permanent magnets 22(N), 24(S) and the first cylindrical magnet 96 and second cylindrical magnet 98 could be constructed of non-ferrous materials or ferrous materials.

In variations of the permanent magnet motor 2, the number of magnets 22(N), 24(S) could be decreased to reduce the diameter size of the motor, or increased to increase the diameter size of the motor.

Several of the permanent magnet motors 2 could also be sacked or connected together on a common shaft to increase the power of the motor.

As various modifications could be made in the construction of the permanent magnet motor and its method of operation herein described and illustrated without departing from the scope of the invention, it is intended that all matter contained in the foregoing description or shown in the accompanying drawings shall be interpreted as illustrative rather than limiting. Thus, the breadth and scope of the present disclosure should not be limited by any of the above described exemplary embodiments, but should be defined only in accordance with the following claims appended hereto and their equivalents.

1. A motor comprising:
a base;
a plurality of magnets, the plurality of magnets are mounted on the base in a circular arrangement, the circular arrangement having an axis that is a vertical axis of rotation;
a center shaft, the center shaft being coaxial with the axis of rotation;
a gear box mounted on the center shaft;
a first radial shaft, the first radial shaft extending radially out from the gear box, the first radial shaft having a horizontal axis of rotation;
a second radial shaft, the second radial shaft extending radially out from the gear box, the second radial shaft having a horizontal axis of rotation;
a first cylindrical magnet, the first cylindrical magnet being mounted on the first radial shaft over the circular arrangement of the plurality of magnets; and,
a second cylindrical magnet, the second cylindrical magnet being mounted on the second radial shaft over the circular arrangement of the plurality of magnets.

2. The motor of claim 1, further comprising:
the first cylindrical magnet has opposite halves on opposite sides of the first radial shaft, the opposite halves of the first cylindrical magnet have opposite north and south polarities on opposite sides of the first radial shaft; and,
the second cylindrical magnet has opposite halves on opposite sides of the second radial shaft, the opposite halves of the second cylindrical magnet have opposite north and south polarities on opposite sides of the second radial shaft.

3. The motor of claim 2, further comprising:
the circular arrangement of the plurality of magnets comprises magnets with north pole polarity surfaces facing upwardly that alternate with magnets with south pole polarity surfaces facing upwardly.

4. The motor of claim 1, further comprising:
the base having a top surface; and,
the plurality of magnets having surfaces facing upwardly that are positioned at an angle relative to the top surface of the base.

5. The motor of claim 1, further comprising:
there being an equal spacing between adjacent magnets of the plurality of magnets.

6. The motor of claim 1, further comprising:
a first wheel mounted on the first radial shaft, the first wheel being on an opposite side of the first cylindrical magnet from the gear box; and,
a second wheel mounted on the second radial shaft, the second wheel being on an opposite side of the second cylindrical magnet from the gear box.

7. The motor of claim 6, further comprising:
the first cylindrical magnet being secured to the first radial shaft for rotation of the first cylindrical magnet with rotation of the first radial shaft;
the second cylindrical magnet being secured to the second radial shaft for rotation of the second cylindrical magnet with rotation of the second radial shaft;
the first wheel being mounted on the first radial shaft for rotation of the first wheel relative to the first radial shaft; and,
the second wheel being mounted on the second radial shaft for rotation of the second wheel relative to the second radial shaft.

8. The motor of claim 1, further comprising:
each magnet of the plurality of magnets is a permanent magnet.

9. The motor of claim 8, further comprising:
the first cylindrical magnet is a permanent magnet; and,
the second cylindrical magnet is a permanent magnet.

10. The motor of claim 9, further comprising:
each permanent magnet of the plurality of magnets is a rare earth magnet;
the permanent magnet of the first cylindrical magnet is a rare earth magnet; and,
the permanent magnet of the second cylindrical magnet is a rare earth magnet.

11. The motor of claim 9, further comprising:
the base is constructed of non-magnetic materials.

12. A motor comprising:
a base constructed of non-magnetic materials;
a plurality of permanent magnets, the plurality of permanent magnets are positioned in a circular arrangement on the base, the circular arrangement of the plurality of permanent magnets having a vertical center axis that is a vertical center axis of rotation;
the plurality of permanent magnets having alternating north pole polarity surfaces facing vertically upwardly and south pole polarity surfaces facing vertically upwardly;
a center shaft, the center shaft having a center axis that is coaxial with the vertical axis of rotation;
a gear box mounted on the center shaft;
a first radial shaft, the first radial shaft being mounted to the gear box extending radially out from the gear box, the first radial shaft having a horizontal axis of rotation;
a second radial shaft, the second radial shaft being mounted to the gear box on an opposite side of the gear box from the first radial shaft, the second radial shaft extending radially out from the gear box, the second radial shaft having a horizontal axis of rotation that is coaxial with the horizontal axis of rotation of the first radial shaft;
a first cylindrical magnet on the first radial shaft over the circular arrangement of the plurality of permanent magnets; and,
a second cylindrical magnet on the second radial shaft over the circular arrangement of the plurality of permanent magnets.

13. The motor of claim 12, further comprising:
the first cylindrical magnet has opposite halves on opposite sides of the horizontal axis of rotation of the first radial shaft, the opposite halves of the first cylindrical magnet have opposite north and south polarities on opposite sides of the horizontal axis of rotation of the first radial shaft; and,
the second cylindrical magnet has opposite halves on opposite sides of the horizontal axis of rotation of the second radial shaft, the opposite halves of the second cylindrical magnet have opposite north and south polarities on opposite sides of the horizontal axis of rotation of the second radial shaft.

14. The motor of claim 13, further comprising:
the first cylindrical magnet being secured to the first radial shaft for rotation of the first cylindrical magnet with rotation of the first radial shaft; and,
the second cylindrical magnet being secured to the second radial shaft for rotation of the second cylindrical magnet with rotation of the second radial shaft.

15. The motor of claim 14, further comprising:
a first wheel of non-magnetic material mounted on the first radial shaft, the first wheel being on an opposite side of the first cylindrical magnet from the gear box; and,
a second wheel of non-magnetic material mounted on the second radial shaft, the second wheel being on an opposite side of the second cylindrical magnet from the gear box.

16. The motor of claim 15, further comprising:
the first cylindrical magnet is a permanent magnet; and,
the second cylindrical magnet is a permanent magnet.

17. The motor of claim 12, further comprising:
the base having a top surface; and,
each permanent magnet of the plurality of permanent magnets having a surface facing upwardly that is positioned at an angle relative to the top surface of the base.

18. The motor of claim 17, further comprising:
the surfaces facing upwardly of the plurality of permanent magnets are each positioned at a same angle relative to the top surface of the base.

19. The motor of claim 12, further comprising:
there being a spacing between adjacent permanent magnets of the plurality of permanent magnets, the spacing between adjacent permanent magnets of the plurality of permanent magnets being a same spacing.

20. The motor of claim 12, further comprising:
each permanent magnet of the plurality of permanent magnets is a rare earth magnet;
the first cylindrical magnet is a rare earth magnet; and,
the second cylindrical magnet is a rare earth magnet.
